(19) United States
(12) Patent Application Publication
(10) Pub. No.: US 2012/0128820 A1
(43) Pub. Date: May 24, 2012

(54) Freezer-to-Oven Dough Products and Methods of Preparation

(76) Inventors: John Graves, St. Paul, MN (US); Kristi Bahe, Coon Rapids, MN (US)

(21) Appl. No.: 13/301,883

(22) Filed: Nov. 22, 2011

Related U.S. Application Data
(60) Provisional application No. 61/416,554, filed on Nov. 23, 2010.

(51) Int. Cl. A21D 2/18; A21D 2/14; A21D 8/02; A21D 10/02; A21D 6/00

(52) U.S. Cl. 426/19; 426/549; 426/496

(57) ABSTRACT

A frozen or refrigerated dough product suitable for making a biscuit product is described. The dough product includes pectin, and the biscuit product has an improved texture in comparison to a corresponding biscuit product made without pectin.

### CROSS-REFERENCE TO RELATED APPLICATIONS

This application claims the benefit of priority under 35 U.S.C. 119(e)(1) of a provisional patent application, Ser. No. 61/416,554, filed Nov. 23, 2010, which is incorporated herein by reference in its entity.

### TECHNICAL FIELD

The invention relates to the use of pectin in dough to prepare dough products. Specifically, the invention relates to the use of pectin in biscuit dough to improve biscuit texture.

### BACKGROUND

Biscuits are an extremely popular food product and have been a staple part of a traditional meal for centuries. Biscuits generally have a very tender, soft, moist and fluffy interior crumb texture, and a somewhat firmer but still tender crust. It is difficult to maintain the desired fluffy, moist and tender texture of freshly baked biscuits for an extended period of time after they are baked. In restaurants, cafeterias and other retail food or foodservice outlets, baked biscuits may be kept in a heating device, such as a holding or warming cabinet, for several hours after baking before they are served to consumers. A typical amount of time for a biscuit to be in a heating device prior to serving can range from about two to four hours, and a typical temperature inside a heating device is approximately 150° F. The time spent in a heating device can have a negative effect on the texture and appearance of biscuits, as the biscuits tend to become stale and hard at these holding temperatures over a period of time.

Biscuits for commercial distribution may be frozen or refrigerated in dough form, and then baked at the retail food or foodservice outlet prior to consumption. Examples of frozen dough compositions are described in U.S. Pat. Nos. 6,579,554, 6,884,443, 7,341,753, and 7,371,421, which are incorporated by reference herein in their entireties. Moisture is lost from the dough during storage at freezer or refrigerator temperatures, and additional moisture is lost when the dough is baked prior to consumption. Moisture loss during storage and subsequent baking results in staling and hardening of the biscuit. Biscuits prepared from frozen or refrigerated dough may therefore be dry, with a hard texture. Holding these biscuits in a heating device for a period of time serves to exacerbate the deterioration of the textural attributes of the biscuit.

As used herein, “freezer-to-oven” refers to a product which has been frozen or refrigerated, and which is then baked directly from the frozen or refrigerated state without needing to be thawed or proofed, prior to eating. As used herein, “freezer-to-oven dough product” refers to a dough which has been refrigerated or frozen prior to baking, and which can be baked directly from the frozen or refrigerated state, without the need for thawing or proofing prior to baking.

### SUMMARY

It has been discovered that adding pectin to biscuit dough improves the texture of freezer-to-oven biscuits made from the biscuit dough.

The invention is directed to a freezer-to-oven dough product suitable for making a biscuit product. The biscuit product has an improved texture as compared to a biscuit made from a freezer-to-oven dough which does not contain pectin.

The invention is also directed to a chemically leavened freezer-to-oven dough product including pectin and whey protein. Biscuits made from this dough product exhibit superior textural properties when compared to a biscuit made from a freezer-to-oven dough which does not contain pectin.

The invention is further directed to a method of making a biscuit product, including preparing a dough containing pectin, freezing or refrigerating the dough to make a refrigerated or frozen dough product, and baking the refrigerated or frozen dough product to make a biscuit product having an improved texture in comparison to a corresponding biscuit product made without pectin.

The foregoing has outlined the features and technical advantages of the invention in order that the detailed description of the invention that follows may be better understood. Additional features of the invention which form the subject of the claims of invention will be described hereinafter. It should be appreciated by those skilled in the art that the specific embodiments disclosed may be readily utilized as a basis for modifying or developing other compositions for carrying out the same purposes of the invention. It should also be realized by those skilled in the art that such equivalent compositions do not depart from the spirit and scope of the invention as set forth in the appended claims. The novel features which are believed to be characteristic of the invention, both as to its composition, its chemical functionality, and process for making the composition, together with further objects and advantages will be better understood from the following description when considered in connection with the accompanying figures. It is to be expressly understood, however, that each of the figures is provided for the purpose of illustration and description only and is not intended as a definition of the limits of the invention.

### BRIEF DESCRIPTION OF THE DRAWINGS

FIG. 1a is a bar graph showing the effect of pectin esterification an biscuit firmness, and FIG. 1b is a bar graph showing the effect of pectin esterification on biscuit crumb spring-back.

FIG. 2a is a bar graph showing the effect of pectin level on biscuit firmness, FIG. 2b is a bar graph showing the effect of pectin level on biscuit crumb spring-back, FIG. 2c is a bar graph showing the effect of pectin level on baked specific volume, and FIG. 2d is a bar graph showing the effect of pectin level on biscuit bake height.

FIG. 3a is a bar graph showing the effect of heating device hold time on biscuit firmness, and FIG. 3b is a bar graph showing the effect of heating device hold time on biscuit crumb spring-back.

FIG. 4a is a bar graph showing the effect of formula modifications on biscuit firmness, and FIG. 4b is a bar graph showing the effect of formula modifications on biscuit crumb spring-back.

FIG. 5a is a bar graph showing the effect of whey protein on biscuit firmness, FIG. 5b is a bar graph showing the effect of whey protein on biscuit crumb spring-back, FIG. 5c is a bar graph showing the effect of whey protein on baked specific volume, and FIG. 5d is a bar graph showing the effect of whey protein on biscuit bake height.

FIG. 6a is a bar graph showing the effect of various hydrocolloids on biscuit firmness, and FIG. 6b is a bar graph showing the effect of various hydrocolloids on biscuit crumb spring-back.

### DETAILED DESCRIPTION OF THE PREFERRED EMBODIMENTS

Freezer-to-oven biscuits made with pectin-containing biscuit dough have improved after-bake holding stability and textural properties, such as tenderness, moistness and fluffiness, as compared to biscuits made without pectin.

The freezer-to-oven dough product prepared with pectin yields biscuits with a more moist, more tender, and fluffier texture than biscuits made from a dough prepared without pectin. The improvement in biscuit texture is still substantially discernible even after the biscuits have been held for several hours in a heating device after baking.

Pectin is a plant-derived polysaccharide including 1,4-linked α-D-galactouronic acid residues. In nature, approximately 80% of the galactouronic acid residues are esterified with methanol. During pectin extraction from plants, up to approximately 72% of the galactouronic acid residues in pectin are esterified. The degree of esterification of pectin may be increased after extraction, through the chemical esterification of pectin with methanol. Pectins with a degree of esterification up to about 85-90% may be produced through chemical esterification. The degree of esterification of pectin may also be decreased after extraction. Altering the degree of esterification changes the functionality of the pectin. Pectin with a degree of esterification of 50% or greater is referred to as “high ester pectin”. Pectin with a degree of esterification of less than 50% is referred to as “low ester pectin”. In the Examples that follow, pectins having a degree of esterification of 30%, 60% and 72% were used to compare the functionality of each type of pectin in a biscuit product. Another type of modified pectin is amidated pectin, in which some of the galacturonic acid is converted, with ammonia, to carboxylic acid amide. Amidated pectin is more tolerant of varying calcium concentrations that occur in use. These various types of pectins are commercially available from CP Kelco U.S., Inc., Atlanta, Ga., United States.

The amount of pectin added to a biscuit dough as described herein may be in the range of from about 0.01% to about 1.5%, or from about 0.05% to about 1%, or from about 0.15% to about 0.3% by weight of the dough. All percentages used herein refer to percent by total weight of the dough unless indicated otherwise.

While adding pectin to biscuit dough yields an improvement in biscuit texture, it has been unexpectedly discovered that adding both pectin and whey protein to a biscuit dough results in freezer-to-oven biscuits with an even better texture than freezer-to-oven biscuits made by adding just pectin to a dough. Specifically, pectin and whey protein appear to show a synergistic effect in increasing biscuit baked specific volume (BSV) and height. While not intending to be bound by theory, it is believed that pectin and whey protein operate synergistically to strengthen the interior cell structure, thereby enabling larger gas bubbles to form and to stabilize the formation of gas bubbles in the dough. The stronger structure and stabilized gas bubbles in the dough are believed to be able to better withstand the rigors of freezing and then baking, resulting in a baked biscuit with improved textural properties as compared to a biscuit made without pectin and whey protein.

Other types of proteins or protein sources, such as egg or dairy sources, can be added to provide these structural and stability benefits, although it is important to balance the structure-enhancing properties of these proteins in the biscuit product with the possible negative impact of a tougher or more firm texture if too much protein is added. Examples of proteins include albumin (in dry or liquid form), sodium caseinate and whey protein.

Other hydrocolloids may be used instead of, or in addition to, pectin. Useful hydrocolloids may include xanthan gum, hydroxypropyl methylcellulose (HPMC), gelatin, alginates such as sodium alginate and propylene glycol alginate (PGA), and the like.

Leavening agents, such as chemical leavening agents and yeast leavening agents, are used in the dough. Acidic leavening agents that may be useful include those generally known in the dough and bread-making arts. Acidic leavening agents may be encapsulated. Examples of acidic leavening agents include sodium aluminum phosphate (SALP), sodium acid pyrophosphate (SAPP), monosodium phosphate, monocalcium phosphate (MCP), anhydrous monocalcium phosphate (AMCP), dicalcium phosphate dehydrate (DCPD), calcium acid pyrophosphate (CAPP), among others.

Useful basic chemical leavening agents are known in the dough and bread-making arts, and include sodium bicarbonate (baking soda), potassium bicarbonate, ammonium bicarbonate, and the like. Basic chemical leavening agents may also include encapsulated leavening agents.

Other ingredients can be added to the dough, such as: flavorings, including salt, sugar and dairy ingredients; wheat protein isolate; and emulsifiers. Examples of emulsifiers that may be used include, but are not limited to, diacetyl tartaric acid ester of monoglyceride (DATEM), sodium stearoyl lactylate (SSL), lecithin, and mono- and di-glycerides.

A general formula for a biscuit dough includes about 25-50% flour, about 25-50% water, and about 10-25% fat or oil, with the balance made up of leavening agents, emulsifiers, flavorings and other ingredients, each at a level of less than about 2% by weight of the dough.

Various quantitative tests were conducted on the biscuits to confirm the qualitative sensory improvements described above. These tests included: a base formula comparison; testing of different pectin esterification levels; testing of different pectin levels; testing of different heating device hold times; testing of a formula like the control except for the addition of pectin, eliminating all other formula modifications; testing of formulas with and without whey protein; and the testing of other hydrocolloids besides pectin.

Each of the foregoing parameters was evaluated by testing biscuit attributes. The biscuit attributes tested included firmness, spring-back, baked specific volume, and height. These attributes are generally what consumers perceive as a “fluffy” texture.

The firmness represents the force, in grams, that must be applied to a product in order to compress the product crumb by a distance of 12 mm. One example of the type of equipment used to measure firmness is a TA-XT2i texture analyzer available from Micro Stable Systems. Based on consumer preferences, a firmness of less than about 2900 g is desirable for a tender biscuit.

The spring-back, or “springiness”, represents the percentage that the crumb springs back after pressure is applied to the crumb. Spring-back is measured as the difference, in %, of the time the compression platen meets the sample's surface between the first and second compression strokes, and can be measured using the same equipment used to measure firmness. If there is a lack of spring-back, a baked product can feel doughy in the mouth. However, if there is too much spring-back, baked product texture can feel rubbery in the mouth. Based on consumer preference, the optimum level of spring-back or springiness is between about 60% and about 75%.

The baked specific volume of a biscuit is a function of the type of leavening agent or agents used, fat level, flour type, emulsifiers, dough conditioners, the mixing and proofing conditions, and the baking conditions. A biscuit with a high baked specific volume is generally perceived to be a fluffier biscuit. The baked specific volume of the biscuits was measured by a TexVol Instruments BVM-L370. Useful baked specific volumes of the biscuits can range from 2.0 cc/g to 3.0 cc/g.

Generally, the height of a biscuit product will vary depending on the diameter of the biscuit and the weight of the dough from which the biscuit was prepared. A taller biscuit is generally perceived to be a fluffier biscuit. The bake heights provided in the following examples were the heights of baked biscuits which each had an unbaked diameter of about 2.75 inches, and which were made from about 62.5 g of dough. The bake heights of biscuits with an unbaked diameter of about 2.75 inches in diameter, and that are made from about 62.5 g of dough, typically range from about 3.0 cm to 5.0 cm.

The following Examples describe the preparation and analysis of biscuits made in accordance with the invention. Although the following Examples describe the products and processes of the invention, they are not intended to limit the scope of the invention.

### EXAMPLES

Properties of a variety of biscuits were analyzed as discussed below. A “Control” biscuit dough was made using the general formula described above. The dough products containing pectin were made by adding an amount of pectin, whey protein, and modified starch to the Control dough formula as shown in Table 1 and reducing the amount of flour in the Control dough formula by the same amount.

TABLE 1
Pectin-Containing Dough Formulas

| | Pectin | Degree of | Whey Protein | Modified |
|---|---|---|---|---|
| | (% by | Pectin | (% by | Starch |
| | weight | Esterifica- | weight | (% by weight |
| Formula | in dough) | tion (by %) | in dough) | in dough) |
| Pectin I | 0.2 | 72 | 0.27 | 0.55 |
| Pectin II | 0.2 | 60 | 0.27 | 0.55 |
| Pectin III | 0.2 | 30 | 0.27 | 0.55 |
| | | (not | | |
| | | amidated) | | |
| Pectin IV | 0.2 | 30 | 0.27 | 0.55 |
| | | (amidated) | | |

Biscuits were made by mixing the dough ingredients in a bar mixer and sheeting the dough on a Rondo® sheeter. The dough was divided into pieces and the pieces frozen and stored at −10° F. for 2-5 days. The frozen dough pieces were then baked directly from the freezer, without thawing prior to baking, at a temperature of 325° F. for 18-20 minutes. The baked biscuits were then placed in a heating device, set at 150° F., for 2 hours, unless otherwise noted, prior to testing. The resulting biscuits, were tested as described in the following Examples.

### Example 2

### Effect of Pectin Degree of Esterification on Firmness and Spring-Back

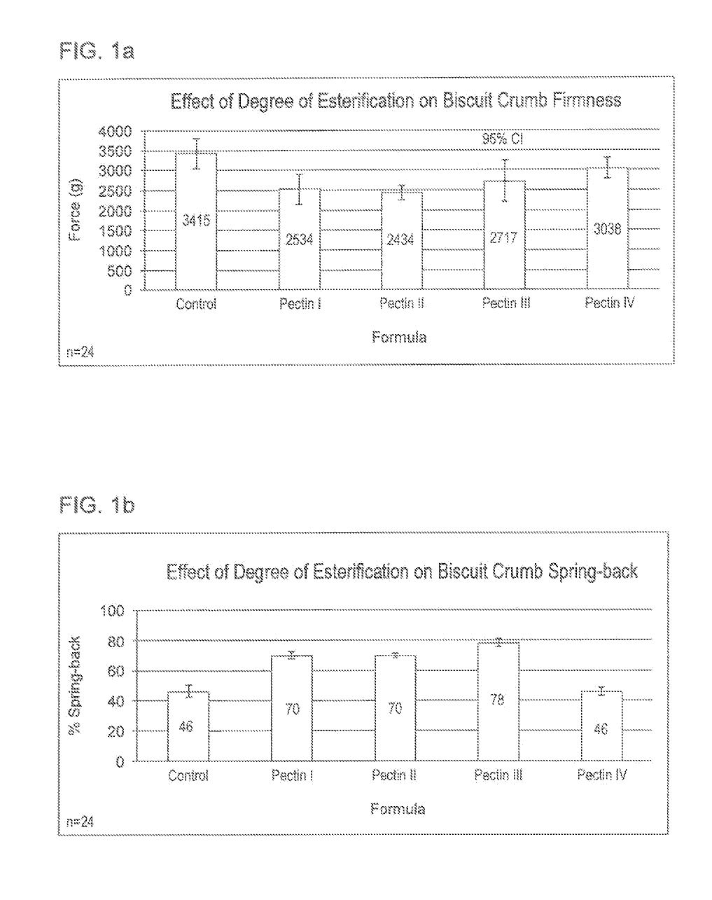

An analysis was conducted on the effect of the degree of pectin esterification on firmness and spring-back, using the testing methods described above. The results are set forth in Table 2 and in FIG. 1.

TABLE 2
Effect of Degree of Pectin Esterification

| | | % Decrease in | | % Increase in |
|---|---|---|---|---|
| | Firmness | Firmness from | Spring-back | Spring-back |
| Formula | (in grams) | Control | (in %) | from Control |
| Control | 3415 | — | 46 | — |
| Pectin I | 2534 | 25.8 | 70 | 52 |
| Pectin II | 2434 | 28.7 | 70 | 52 |
| Pectin III | 2717 | 20.4 | 78 | 70 |
| Pectin IV | 3038 | 11 | 46 | 0 |

FIG. 1a shows the effect of the degree of esterification of pectin on biscuit firmness. The Pectin I, Pectin II and Pectin III biscuit products are significantly less firm than the Control biscuit product, with all of the high ester pectin-containing samples showing a decrease in firmness of at least about 25% from the Control sample. The firmness of the biscuits increased from the high ester pectin samples, Pectin I and Pectin II to the low ester pectin samples, Pectin III and pectin IV with the amidated pectin, Pectin IV, showing little improvement in biscuit crumb softness. As discussed above, consumers prefer a softer and more tender biscuit crumb, which is associated with biscuit products having a firmness of less than about 2900 g, such as the Pectin I, Pectin II and Pectin III biscuit products in Table 2.

FIG. 1b shows the effect of the degree of pectin esterification on biscuit crumb spring-back. The Pectin I, Pectin II and Pectin III biscuit products have significantly higher spring-back than the Control sample, while the amidated pectin, Pectin IV, has no effect on spring-back. Amidated pectin appears to have provided no improvement to the biscuit spring-back. As noted previously, consumers prefer biscuits with a spring-back in the range of about 60% to about 75%, as seen in the Pectin I, Pectin II and Pectin III biscuit products.

### Example 3

### Effect of Pectin Level on Firmness, Spring-Back, BSV, and Bake Height

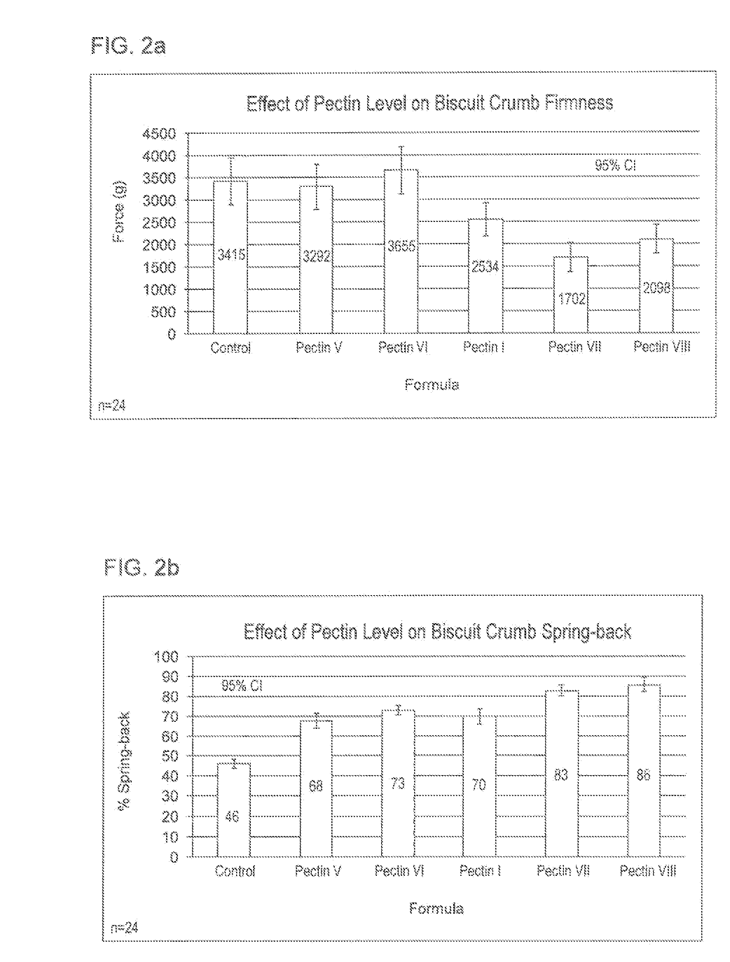

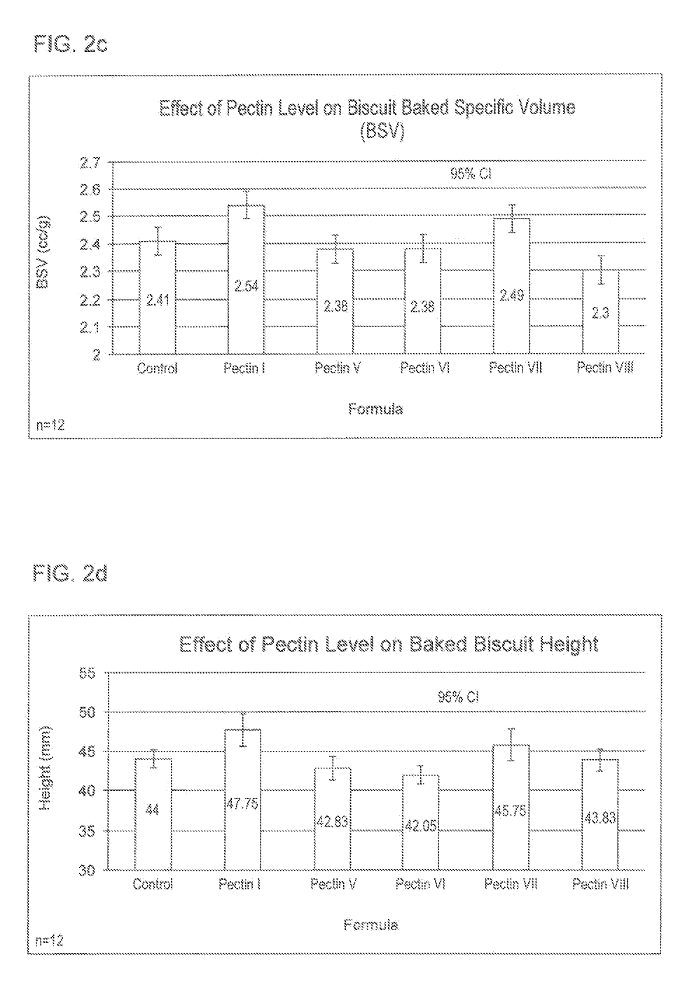

An analysis of the effect of pectin level on firmness, spring-back, baked specific volume (BSV), and bake height was conducted. Control and Pectin I biscuit doughs were prepared as described above. Pectin V dough was prepared using the Pectin I formula, except 0.05% pectin was included in the dough instead of 0.2% pectin. Pectin VI dough was prepared using the Pectin I formula, except 0.1% pectin was included in the dough instead of 0.2% pectin. Pectin VII dough was prepared using the Pectin I formula, except 0.5% was included instead of 0.2% pectin. Pectin VIII dough was prepared using Pectin I formula, except 1.0% pectin was included instead of 0.2% pectin. The results are shown in Table 3 and in FIGS. 2a and 2b.

TABLE 3
Effect of Pectin Level

| | Level of | | | | |
|---|---|---|---|---|---|
| | Pectin in | | Spring- | | Bake |
| | Dough | Firmness | back | BSV | Height |
| Formula | (in %) | (in grams) | (in %) | (in cc/g) | (in mm) |
| Control | — | 3415 | 46 | 2.41% | 44.00 |
| Pectin I | 0.2 | 2534 | 70 | 2.54 | 47.75 |
| % change | | 25.8% | 52.2% | 5.4% | 8.5% |
| from Control | | decrease | increase | increase | increase |
| Pectin V | .05 | 3292 | 68 | 2.38 | 42.83 |
| % change | | 3.6% | 47.8% | 1.2% | 2.7% |
| from Control | | decrease | increase | decrease | decrease |
| Pectin VI | .1 | 3655 | 73 | 2.45 | 44.08 |
| % change | | 7% | 58.7% | 1.7% | .18% |
| from Control | | increase | increase | increase | increase |
| Pectin VII | 0.5 | 1702 | 83 | 2.49 | 45.75 |
| % change | | 50.2% | 80.4% | 3.3% | 4.0% |
| from Control | | decrease | increase | increase | increase |
| Pectin VIII | 1.0 | 2098 | 86 | 2.30 | 43.83 |
| % change | | 38.6% | 87% | 4.6% | 0.4% |
| from Control | | decrease | increase | decrease | decrease |

FIG. 2a shows the effect of pectin level on biscuit firmness. A significant decrease in the firmness of the biscuits, when compared to Control, is not observed until a pectin level of about 0.2% is reached, although a slight decrease in firmness is observed even at a pectin level of 0.05%. The biscuits made with the Pectin VII dough were the least firm, having a firmness of about 50% of the firmness of the Control biscuit. product. This decrease in firmness is perceived by the consumer as improved tenderness.

FIG. 2b shows the effect of pectin level on biscuit crumb spring-back. The Pectin VIII biscuits had the greatest percentage of spring-back,, while the biscuits made without pectin had the lowest percentage of spring-back, with all of the pectin-containing biscuits demonstrating a spring-back that was at least about 45% greater than the Control biscuits. As noted above, consumers prefer biscuits having a spring-back of between about 60% to about 75%. Therefore, the Pectin I, Pectin V and Pectin VI biscuit products had the consumer-preferred levels of spring-back.

FIG. 2c shows the effect of pectin level on BSV. The Pectin I biscuits had the highest BSV, while the Pectin VIII biscuits had the lowest BSV. The BSV of the biscuit increased when the pectin level was increased from 0% to 0.2%. The BSV of the biscuit decreased when the pectin level was increased from 0.2% to 0.5%, but the BSV of the Pectin VI and Pectin VII biscuits were still greater than the BSV of the Control biscuit. Only when the pectin level was increased from 0.5% to 1.0% did the BSV of the pectin-containing biscuit drop below the BSV of the Control biscuit. As described above, a higher BSV is typically preferred by consumers.

FIG. 2d shows the effect of pectin level on the bake height of the biscuit. The Pectin I biscuits had the highest bake height, and the Pectin I, Pectin V, and Pectin VII biscuits had bake heights greater than the Control biscuit product. In general, a higher bake height is perceived more favorably by consumers.

### Example 4

### Effect of Heating Device Hold Time on Firmness and Spring-Back

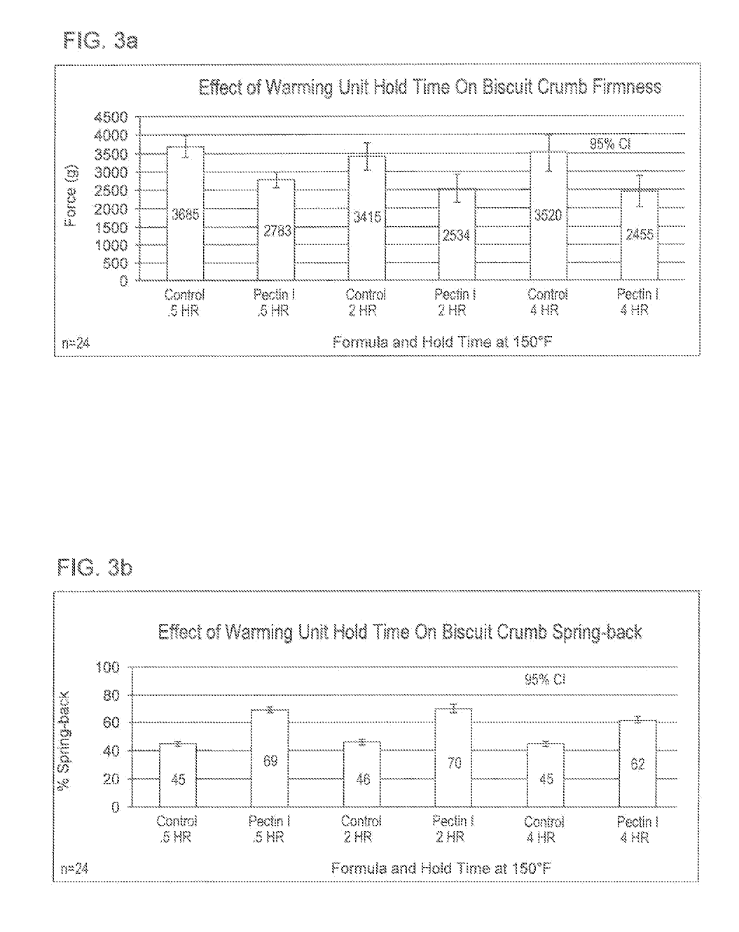

An analysis of the effect of heating device hold time on firmness and spring-back was conducted. Control and Pectin I biscuits were prepared as described above. Samples of biscuits made from each formula were then placed in a 150° F. heating device. One set of biscuits was held in the heating device for 30 minutes prior to testing, a second set of biscuits was held in the heating device for 2 hours prior to testing, and a third set of biscuits was held in the heating device for 4 hours prior to testing. The results are shown in Table 4 and in FIG. 3.

TABLE 4
Effect of Heating device Hold Time

| | Firmness in grams | | | Spring-Back in % | | |
|---|---|---|---|---|---|---|
| | | 2 | 4 | | 2 | 4 |
| | 30 min. | hours | hours | 30 min. | hours | hours |
| Control | 3685 | 3415 | 3520 | 45 | 46 | 45 |
| Pectin I | 2783 | 2534 | 2455 | 69 | 70 | 62 |
| % Change | 24.5% | 25.8% | 30.3% | 53.3% | 52.2% | 37.8% |
| from | de- | de- | de- | in- | in- | in- |
| Control | crease | crease | crease | crease | crease | crease |

FIG. 3a shows the effect of heating device hold time on biscuit firmness, and FIG. 3b shows the effect of heating device hold time on biscuit crumb spring-back. The Pectin I biscuits, which had a 0.2% pectin level, always performed significantly better than the Control biscuits made without pectin, demonstrating between about a 24% to about 30% decrease in firmness over time. The Pectin I biscuits maintained a high, level of spring-back, between about 29% to about 53% greater than the Control biscuits, even after 4 hours in a heating device.

### Example 5

### Effect of Formula Modifications on Firmness and Springiness

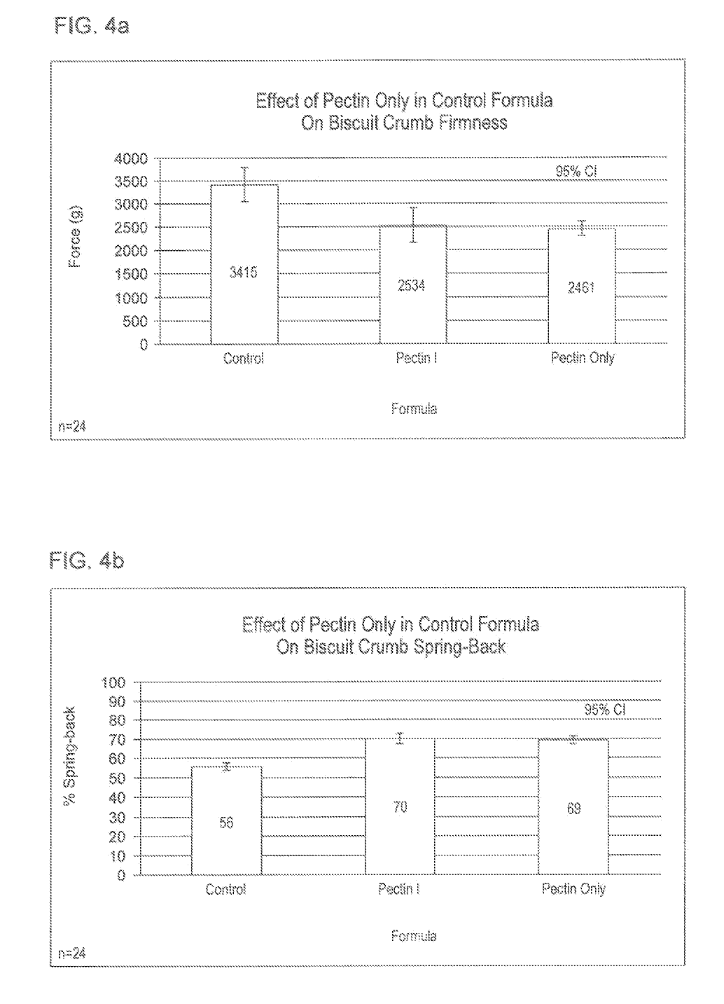

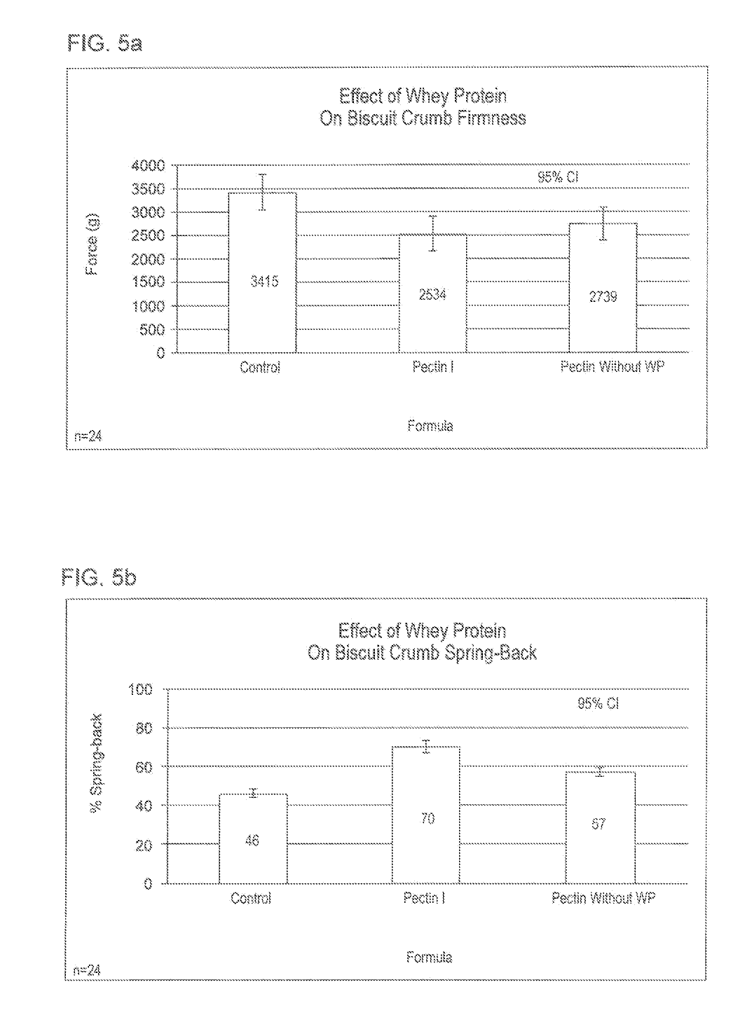

As shown in Table 1, the pectin-containing formulas differ from the Control formula in other ways besides the addition of pectin. Both whey protein and modified starch are included in these pectin formulas, but are not included in the Control formula. To determine the effect of formula modifications, a biscuit was made using an additional formula (hereinafter the “Pectin Only formula”). The Pectin Only formula differed from the Control formula in that the Pectin Only formula included 0.2% pectin, with a concurrent adjustment in the percent by weight of flour as described above. The firmness and spring-back of biscuits made from the Control formula, the Pectin I formula, and the Pectin Only formula were measured. The results are shown in Table 5 and FIG. 4.

TABLE 5
Effect of Modifications to Pectin Containing Formulas

| | Firmness | % Decrease in | Spring-back | % Increase in |
|---|---|---|---|---|
| Formula | (in grams) | Firmness | (in %) | Spring-back |
| Control | 3415 | — | 46 | — |
| Pectin I | 2534 | 25.8 | 70 | 52.2 |
| Pectin Only | 2461 | 27.9 | 70 | 60 |

FIG. 4a shows the effect of formula modifications on biscuit firmness. The biscuits made with the Pectin I formula were the least firm, while the biscuits made with the Control formula were the most firm, with both pectin-containing formulas showing at least about a 25% decrease in firmness as compared to the Control biscuits. FIG. 4b shows the effect of formula modifications on biscuit crumb spring-back, with both pectin-containing biscuits showing an increase in spring-back of at least about 52% over the Control biscuit.

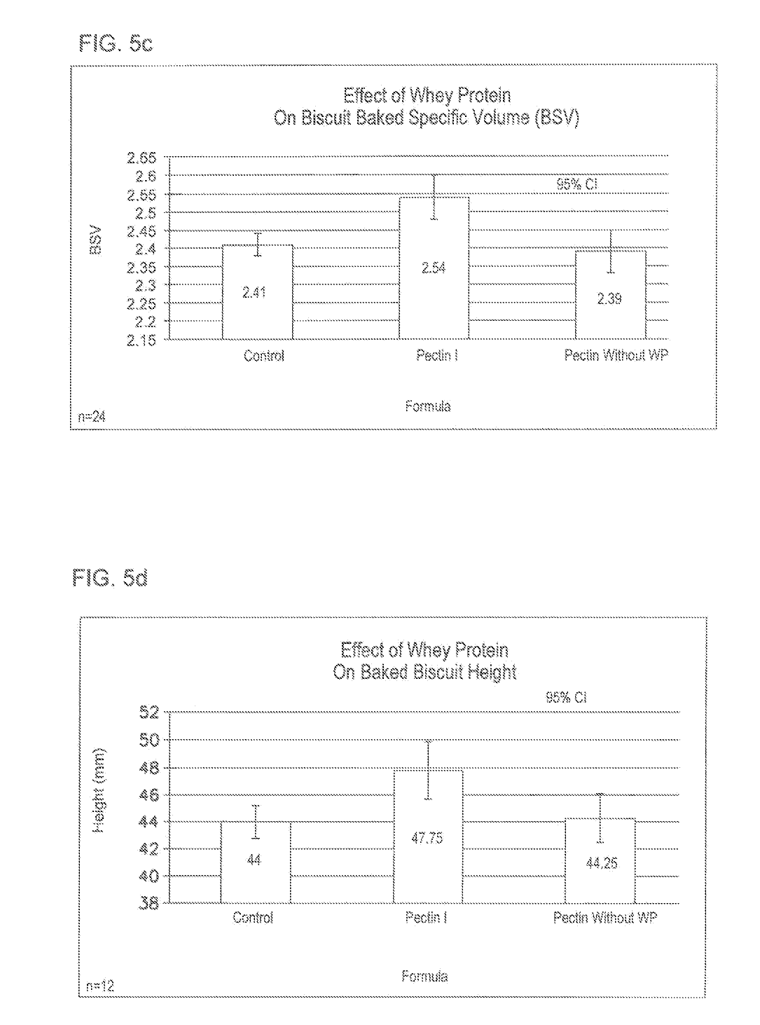

To determine the effect of whey protein on biscuits prepared using the Pectin I formula, a biscuit was made using a formula which was similar to the Pectin I formula, except no whey protein was added (hereinafter the “Pectin Without WP” formula). The firmness, spring-back, BSV, and biscuit height of biscuits made from the Control formula, the Pectin I formula, and the Pectin Without WP formula were measured. The results are shown in Table 6 and FIG. 5.

TABLE 6
Effect of Whey Protein

| | Firmness | Spring-Back | BSV | Bake Height |
|---|---|---|---|---|
| Formula | (in grams) | (in %) | (in cc/g) | (in mm) |
| Control | 3415 | 46 | 2.41 | 44.00 |
| Pectin I | 2534 | 70 | 2.54 | 47.75 |
| % change | 25.8% | 52.2% | 5.4% | 8.5% |
| from Control | decrease | increase | increase | increase |
| Pectin | 2739 | 57 | 2.39 | 44.25 |
| Without WP | | | | |
| % change | 19.8% | 23.9% | 0.8% | 0.6% |
| from Control | decrease | increase | decrease | increase |

FIG. 5a shows the effect of whey protein on biscuit firmness. The biscuits made with the Pectin I formula were the least firm, while the biscuits made with the Control formula were the most firm, but both pectin-containing formulas showed at least about a 19% decrease in firmness as compared to the Control formula. Although the Pectin I formula showed the greatest improvement in lack of firmness over the Control formula, the Pectin Without WP formula still showed a significant improvement. FIG. 5b shows the effect of whey protein on biscuit crumb spring-back. Both the Pectin I and the Pectin Without WP formulas showed a significant improvement in the springiness of the biscuit over the Control formula by at least about 23%. As noted previously, consumers prefer biscuits having a spring-back of between about 60% to about 75%, so the Pectin I biscuit demonstrated the desired level of spring-back.

FIG. 5c shows the effect of whey protein on BSV. The biscuits made with the Pectin I formula had the highest BSV, while the biscuits made with the Pectin Without WP formula had a BSV similar to that of the Control formula biscuits. FIG. 5d shows the effect of whey protein on biscuit height. The biscuits made with the Pectin I formula had the greatest height, while the biscuits made with the Pectin Without WP formula had a height similar to that of the Control formula biscuits. Therefore, whey protein, when included in a biscuit formula with pectin, improved the BSV and biscuit height. While not intending to be bound by theory, and as discussed above, it appears that there are interactions between the pectin and whey protein which create a synergistic effect. As the data show, adding pectin to a dough alone provides an improvement to biscuit texture, but the inclusion of whey protein, in addition to pectin, provides further improvements to the biscuit texture.

### Example 6

### Effect of Different Hydrocolloids on Firmness and Spring-Back

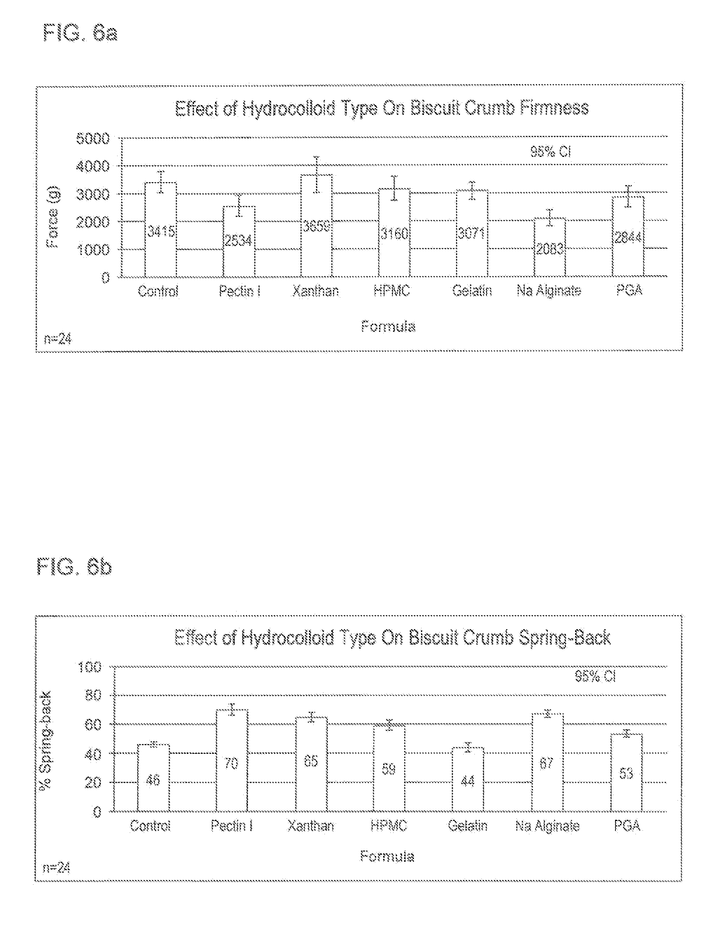

An analysis was conducted on the effect of different hydrocolloids on firmness and spring-back. Biscuits were prepared according to the Control formula and the Pectin I formulas of Table 1. Additional biscuit samples were prepared by substituting pectin with the following hydrocolloids in the Pectin I formula: xanthan, hydroxypropyl methylcellulose (HPMC), gelatin, sodium alginate, and propylene glycol alginate (PGA). The results are set forth in Table 7 and in FIG. 6. The hydrocolloid replacement levels were at 0.2% except for PGA, which was added at level of 0.015%

TABLE 7
Effect of Different Hydrocolloids

| | Firmness | % Decrease | Spring-back | % Increase in |
|---|---|---|---|---|
| Formula | (in grams) | in Firmness | (in %) | Spring-back |
| Control | 3415 | — | 46.0 | — |
| Pectin I | 2534 | 25.8 | 70.0 | 52.2 |
| Xanthan | 3659 | (7.1% | 65 | 41.3 |
| | | increase) | | |
| HPMC | 3160 | 7.5 | 59.0 | 28.2 |
| Gelatin | 3071 | 10.0 | 44.0 | (4.3% |
| | | | | decrease) |
| Sodium | 2083 | 39.0 | 67 | 45.7 |
| alginate | | | | |
| PGA | 2844 | 17.0 | 53.0 | 15.2 |

FIG. 6a shows the effect of different hydrocolloids on biscuit firmness. The biscuits made with the Pectin I formula were the least firm, while the biscuits made with xanthan were the most firm. The biscuits made with HPMC, gelatin, sodium alginate and PGA had a firmness less than that of the Control biscuits, but greater than the Pectin I biscuits. FIG. 6b shows the effect of different hydrocolloids on biscuit crumb spring-back. The biscuits made with the Pectin I formula had the greatest percentage of spring-back, while the biscuits made with gelatin had the lowest percentage of spring-back. The biscuits made with xanthan, HPMC, sodium alginate and PGA had a spring-back greater than that of the Control biscuits, but less than the Pectin I biscuits. Therefore, pectin, HPMC, sodium alginate and PGA in a biscuit dough formula each demonstrated an improvement over the Control formula. Without intending to be bound by theory, it appears that the behavior of some hydrocolloids in water is different from the behavior of other hydrocolloids in water, and this difference in behavior may be reflected in the effect of these hydrocolloids in a biscuit product.

As described above, the freezer-to-oven biscuits of the invention exhibit a decrease in firmness of between about 20% to about 50%, or between about 23% to about 45%, as compared to a control freezer-to-oven biscuit made without pectin. The biscuits of the invention demonstrate an increase in spring-back or springiness of between about 30% to about 80%, or between about 35% to about 65%, as compared to the control biscuit. The baked specific volume of the biscuit of the invention is between about 2.0 cc/g to about 3.0 cc/g, or between about 2.3 cc/g to about 2.6 cc/g. The bake height of a biscuit of the invention made from about 62.5 g of dough and having a diameter of about 2.75 inches is between about 4.0 cm to about 5.0 cm, or about 4.4 cm to about 4.8 cm. All of these attributes contribute to the overall sensory perception that the biscuits of the invention have an improved texture as compared to the control biscuits.

Although the invention and its advantages have been described in detail, it should be understood that various changes, substitutions and alterations can be made herein without departing from the spirit and scope of the invention as defined by the appended claims. Moreover, the scope of the application is not intended to be limited to the particular embodiments of the invention described in the specification. As one of ordinary skill in the art will readily appreciate from the disclosure of the invention, the compositions, processes, methods, and steps, presently existing or later to be developed that perform substantially the same function or achieve substantially the same result as the corresponding embodiments described herein may be utilized according to the invention.

What is claimed is:

1. A freezer-to-oven dough product suitable for making a biscuit product, said dough product comprising pectin, wherein the biscuit product has an improved texture in comparison to a corresponding biscuit product made without pectin.

2. The freezer-to-oven dough product of claim 1, further comprising a protein source.

3. The freezer-to-oven dough product of claim 1, wherein the pectin is present in the dough product in a range of from about 0.01% to about 1.5% by weight.

4. The freezer-to-oven dough product of claim 1, wherein the pectin is present in the dough product in a range of from about 0.05% to about 1.0%.

5. The freezer-to-oven dough product of claim 1, wherein the pectin is present in the dough product in a range of from about 0.15% to about 0.3%.

6. The freezer-to-oven dough product of claim 1, wherein the biscuit product has a biscuit crumb firmness of less than about 2900 g.

7. The freezer-to-oven dough product of claim 1, wherein the biscuit product has a biscuit crumb firmness of less than about 2900 g after the biscuit product has been held for about 2 hours at a temperature of about 150° F.

8. The freezer-to-oven dough product of claim 1, wherein the biscuit product has a biscuit crumb firmness of less than about 2900 g after the biscuit product has been held for about 4 hours at a temperature of about 150° F.

9. The freezer-to-oven dough product of claim 1, wherein the biscuit product has a biscuit crumb spring-back in a range of from about 60% to about 75%.

10. The freezer-to-oven dough product of claim 1, wherein the biscuit product has a biscuit crumb spring-back in a range of from about 60% to about 75% after the biscuit product has been held for about 2 hours at a temperature of about 150° F.

11. The freezer-to-oven dough product of claim 1, wherein the biscuit product has a biscuit crumb spring-back in a range of from about 60% to about 75% after the biscuit product has been held for about 4 hours at a temperature of about 150° F.

12. The freezer-to-oven dough product of claim 1, further comprising a chemical leavening agent.

13. The freezer-to-oven dough product of claim 1, wherein the protein source is selected from the group consisting of an egg protein or a dairy protein.

14. A chemically leavened freezer-to-oven dough product suitable for making a biscuit product, said dough product comprising:
pectin in a range of from about 0.01% to about 1.5% by weight; and
a protein source,
wherein the biscuit product has an improved texture in comparison to a corresponding biscuit product made without pectin, and
wherein the biscuit product has a biscuit crumb firmness of less than about 2900 g, and a biscuit crumb spring-back in a range of from about 60% to about 75%, after the biscuit product has been held for about 2 hours to about 4 hours at a temperature of about 150° F.

15. A method of making a biscuit product comprising:
preparing a dough comprising pectin;
refrigerating or freezing the dough to make a refrigerated or frozen dough product; and
baking the refrigerated or frozen dough product to make a biscuit product having an improved texture in comparison to a corresponding biscuit product made without pectin.

16. The method of claim 15, wherein the dough further comprises a protein source.

17. The method of claim 15, wherein the dough further comprises a chemical leavening agent.

18. The method of claim 15, wherein the protein source is selected from the group consisting of and egg protein or a dairy protein.

19. The method of claim 15, further comprising holding the biscuit product at a temperature of about 150° F. for about 2 to about 4 hours after the baking step.

20. The method of claim 19, wherein the biscuit product has a biscuit crumb firmness of less than about 2900 g after the holding step.
